(19) United States
(12) Patent Application Publication
(10) Pub. No.: US 2002/0187288 A1
(43) Pub. Date: Dec. 12, 2002

(54) Medical device formed of silicone-polyurethane

(75) Inventors: Florencia Lim, Union City, CA (US); Christopher J. Buchko, Redwood City, CA (US); Ashok A. Shah, San Jose, CA (US); Murthy V. Simhambhatla, San Jose, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(73) Assignee: Advanced Cardiovascular Systems, Inc.

(21) Appl. No.: 09/879,023

(22) Filed: Jun. 11, 2001

(51) Int. Cl. B32B 1/08

(52) U.S. Cl. 428/35.2; 428/36.9; 264/211.19

(57) ABSTRACT

A medical device, and particularly an intracorporeal device for therapeutic or diagnostic use, comprising a silicone polyurethane. One embodiment of the invention is a medical device having a body formed of melt process extruded, porous silicone polyurethane material. In a method of the invention, the silicone polyurethane is combined with a porogen and then melt process extruded into a desired shape such as a tubular body. The porogen is then extracted from the extrudate, to form the extruded, melt processed, porous silicone polyurethane tubular body. The medical device, such as a stent cover, vascular graft, or catheter balloon, formed of the silicone polyurethane has excellent biostability, strength, and flexibility.

### BACKGROUND OF THE INVENTION

This invention generally relates to medical devices, and particularly to intracorporeal devices for therapeutic or diagnostic uses such as balloon catheters, stent covers, and vascular grafts.

In percutaneous transluminal coronary angioplasty (PTCA) procedures, a guiding catheter is advanced until the distal tip of the guiding catheter is seated in the ostium of a desired coronary artery. A guidewire, positioned within an inner lumen of a dilatation catheter, is first advanced out of the distal end of the guiding catheter into the patient's coronary artery until the distal end of the guidewire crosses a lesion to be dilated. Then the dilatation catheter having an inflatable balloon on the distal portion thereof is advanced into the patient's coronary anatomy, over the previously introduced guidewire, until the balloon of the dilatation catheter is properly positioned across the lesion. Once properly positioned, the dilatation balloon is inflated with fluid one or more times to a predetermined size at relatively high pressures (e.g. greater than 8 atmospheres) so that the stenosis is compressed against the arterial wall and the wall expanded to open up the passageway. Generally, the inflated diameter of the balloon is approximately the same diameter as the native diameter of the body lumen being dilated so as to complete the dilatation but not overexpand the artery wall. Substantial, uncontrolled expansion of the balloon against the vessel wall can cause trauma to the vessel wall. After the balloon is finally deflated, blood flow resumes through the dilated artery and the dilatation catheter can be removed therefrom.

In such angioplasty procedures, there may be restenosis of the artery, i.e. reformation of the arterial blockage, which necessitates either another angioplasty procedure, or some other method of repairing or strengthening the dilated area. To reduce the restenosis rate and to strengthen the dilated area, physicians frequently implant a stent inside the artery at the site of the lesion. Stents may also be used to repair vessels having an intimal flap or dissection or to generally strengthen a weakened section of a vessel. Stents are usually delivered to a desired location within a coronary artery in a contracted condition on a balloon of a catheter which is similar in many respects to a balloon angioplasty catheter, and expanded to a larger diameter by expansion of the balloon. The balloon is deflated to remove the catheter and the stent left in place within the artery at the site of the dilated lesion. Stent covers on an inner or an outer surface of the stent have been used in, for example, the treatment of pseudo-aneurysms and perforated arteries, and to prevent prolapse of plaque. Similarly, vascular grafts comprising cylindrical tubes made from tissue or synthetic materials such as DACRON, may be implanted in vessels to strengthen or repair the vessel, or used in an anastomosis procedure to connect vessels segments together.

It would be a significant advance to provide a stent cover or other medical device component with improved biostability, strength, and manufacturability.

### SUMMARY OF THE INVENTION

This invention is directed to medical devices or components thereof, and particularly intracorporeal devices for therapeutic or diagnostic uses, which are formed at least in part of a silicone polyurethane. One embodiment of the invention is a medical device having a body formed of melt process extruded, porous silicone polyurethane material. In a method of the invention, the silicone polyurethane is combined with a porogen and then melt process extruded into a desired shape such as a tubular body. The porogen is then extracted from the extrudate, to form the extruded, melt processed, porous silicone polyurethane tubular body. The medical device formed of the silicone polyurethane has excellent biostability, strength, and flexibility.

In one embodiment, the medical device is a cover for an endoluminal device such as a stent. However, the medical device of the invention may comprise a variety of devices including a vascular graft, a pacemaker lead cover, and an intravascular catheter component. Stent covers and vascular grafts of the invention generally comprise a tubular body formed at least in part of a silicone polyurethane. The terminology vascular graft as used herein should be understood to include grafts and endoluminal prostheses which are surgically attached to vessels in procedures such as vascular bypass or anastomosis, or which are implanted within vessels, as for example in aneurysm repair or at the site of a balloon angioplasty or stent deployment. Balloon catheters of the invention, such as an angioplasty dilatation catheter or a stent delivery catheter, have a component, such as the catheter balloon, shaft, or a stent cover, which is formed of silicone polyurethane. Balloon catheters of the invention generally comprise an elongated shaft with at least one lumen and balloon on a distal shaft section with an interior in fluid communication with the shaft lumen. In one embodiment, the medical device formed of silicone polyurethane is configured to deliver an agent such as a drug within the patient.

A variety of suitable silicone polyurethanes may be used to form the medical device, including aliphatic and aromatic polyurethanes. Presently preferred silicone polyurethanes include polyether silicone polyurethanes, and polycarbonate silicone polyurethanes, including Elast-Eon 2, and 3, which are siloxane-based polyurethanes available from Elastomedic Pty Limited, and Pursil-10, -20, and -40 TSPU which are poly(tetramethylene-oxide (PTMO) and polydimethylsiloxane (PDMS) polyether-based aromatic silicone polyurethanes available from Polymer Technology Group, and Pursil AL-5, and -10 TSPU which are PTMO and PDMS polyether-based aliphatic silicone polyurethanes available from Polymer Technology Group, and Carbosil-10, -20, and -40 TSPU which are aliphatic, hydroxy-terminated polycarbonate and PDMS polycarbonate-based silicone polyurethanes available from Polymer Technology Group. Additionally, Avocothane-51, available from Arrow International and Polymer Technology Group, which is a silicone-containing block copolymer mixed into a base polymer, may be used. Silicone polyurethane ureas may also be used, which are typically not melt processable unlike the presently preferred silicone polyurethanes. The Pursil, Pursil-AL, and Carbosil are thermoplastic elastomer urethane copolymers containing silicone in the soft segment, and the percent silicone in the copolymer is referred to in the grade name, e.g., Pursil-10 has 10% silicone content. They are synthesized through a multi-step bulk synthesis in which PDMS is incorporated into the polymer soft segment with PTMO (Pursil) or an aliphatic hydroxy-terminated polycarbonate (Carbosil). The hard segment consists of an aromatic diisocyanate, MDI, with a low molecular weight glycol chain extender, or in the case of Pursil-AL the hard segment is synthesized from an aliphatic diisocyanate. The polymer chains are then terminated with a silicone (or other) surface modifying end group. The preferred molecular weight range for the silicone polyurethane materials is about 200 to about 300K. The Shore durometer hardness of the preferred silicone polyurethane materials is about 70A to about 90A. The ultimate elongation of the preferred silicone polyurethane materials is about 300% to about 1000%, and preferably about 450% to about 800%, to produce a flexible, compliant medical device with a high radial elongation to break of typically greater than 350%.

The presently preferred silicone polyurethanes have a relatively low glass transition temperature which provides a medical device component with improved higher flexibility compared with conventional materials. Additionally, the silicone polyurethanes have high hydrolytic and oxidative stability, including improved resistance to environmental stress cracking.

The silicone polyurethane is preferably processed to be porous. Preferably, extractable porogens are used to produce an open-cell microporous silicone polyurethane body forming the medical device or a component thereof. Preferably, melt process extrusion is used to form the body. The terminology melt process extrusion should be understood to refer to extrusion of the polymer softened at an elevated temperature through an extrusion die into the desired shape such as tubing. However, in an alternative embodiment, solvent processing, in which a solution of the silicone polyurethane dissolved in a solvent is dipped coated onto a mandrel to form the tubing, is used. Melt processing is preferred over solvent processing due to the improved manufacturability and ease of processing provided by melt processing. Specifically, melt processing is preferred over solvent processing because melt processing provides improved ability to process large numbers of extrudate samples with uniform thicknesses and with long lengths, improved ability to remove the extrudate sample from the mandrel, and reduced processing times.

Surprisingly, it has been found that the medical device or component thereof, which embodies features of the invention, may be formed of silicone polyurethane by melt process extrusion despite having a large amount of porogen combined with the silicone polyurethane. The effects of the porogen on the melt processibility of the polymeric material include a reduction of the melt strength and an increase in the viscosity of the polymeric material during melt process extrusion. The porogen is typically an inorganic salt such as potassium chloride (KCl), or sodium chloride (NaCl) dissolvably removable from the extruded silicone polyurethane/porogen mixture, although a variety of suitable porogens can be used including polyethyleneglycol (PEG), polyvinylpyrrolidone (PVP, and water soluble salts. The porogen typically has a particle size of about 10 μm to about 500 μm, preferably about 20 μm to about 100 μm, and more specifically about 10 μm to about 40 μm. The silicone polyurethane/porogen mixture is typically about 20% to about 90%, more specifically about 40% to about 70% by weight porogen, for providing a high degree of porosity following extraction of the porogen of about 20% to about 90%, more specifically about 40% to about 70%, by weight of the extrudate. In one embodiment, the porosity is about 20% to about 50% by weight, to provide a medical device component with both a high degree of porosity and a desired strength. The extruded, melt processed, porous body, extruded in the shape of a tubular body, has a uniform wall thickness along the length of the tubing. The uniform wall thickness varies by less than 0.0013 cm to 0.0025 cm, along a 60 cm length of tubing. Additionally, the porogen is uniformly mixed or compounded with the silicone polyurethane, such that the tubing has a uniform porosity which varies by less than 0.01% to 0.5%, along a 60 cm length of tubing.

The medical device having at least a component formed of the silicone polyurethane has improved biostability and flexibility compared to polyether or polycarbonate urethanes, and provides an improved substrate for impregnating with a variety of agents. These and other advantages of the invention will become more apparent from the following detailed description when taken in conjunction with the accompanying exemplary drawings.

### BRIEF DESCRIPTION OF THE DRAWINGS

FIG. 1 is an elevational view, partially in section, of a stent delivery balloon catheter having a covered stent on the catheter balloon, which embodies features of the invention.

FIG. 2 is a transverse cross-section of the catheter shown in FIG. 1 taken at line 2-2.

FIG. 3 is a transverse cross-section of the catheter shown in FIG. 1 taken at line 3-3, showing the covered stent disposed over the inflatable balloon.

FIG. 4 is an elevational view, partially in section, of a vascular graft or stent cover which embodies features of the invention.

FIG. 5 is a transverse cross-section of the graft or cover shown in FIG. 4, taken along lines 5-5.

### DETAILED DESCRIPTION OF THE INVENTION

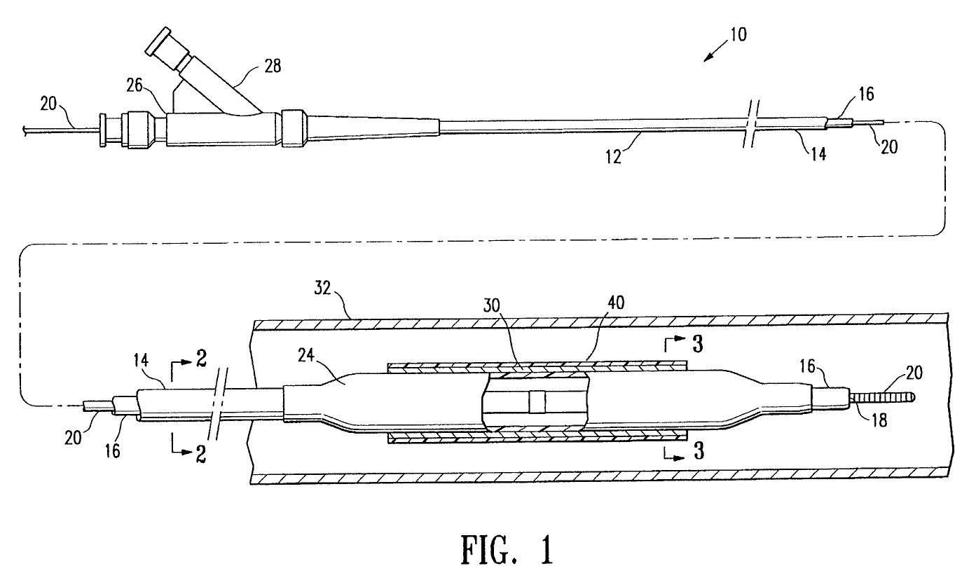

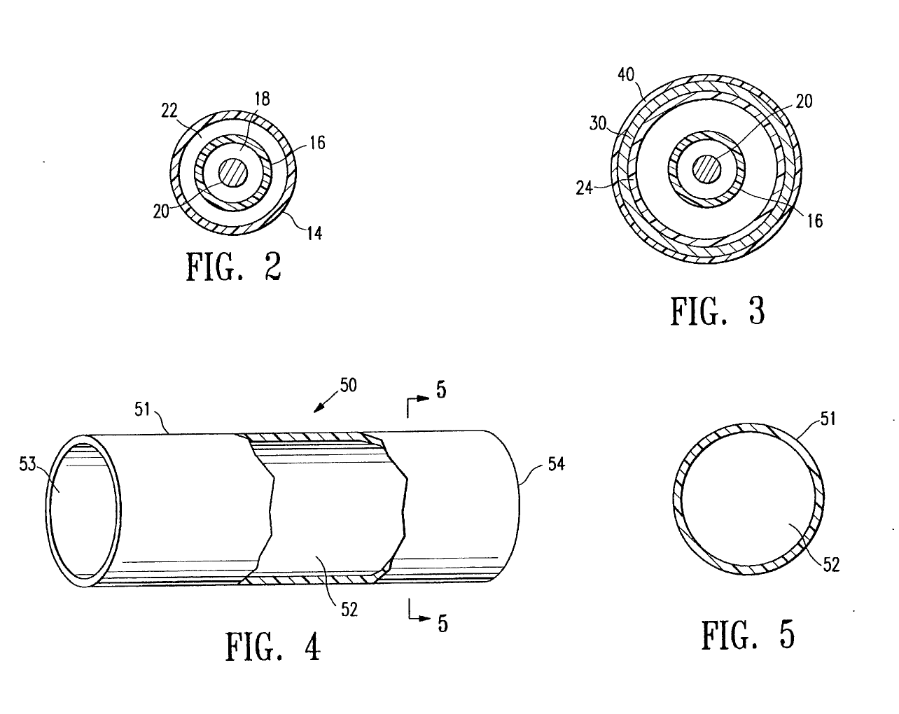

FIGS. 1-3 illustrate an over-the-wire type stent delivery balloon catheter 10 embodying features of the invention. Catheter 10 generally comprises an elongated catheter shaft 12 having an outer tubular member 14 and an inner tubular member 16. Inner tubular member 16 defines a guidewire lumen 18 adapted to slidingly receive a guidewire 20. The coaxial relationship between outer tubular member 14 and inner tubular member 16 defines annular inflation lumen 22 (see FIGS. 2 and 3, illustrating transverse cross sections of the catheter 10 of FIG. 1, taken along lines 2-2 and 3-3 respectively). An inflatable balloon 24 is disposed on a distal section of catheter shaft 12, having a proximal shaft section sealingly secured to the distal end of outer tubular member 14 and a distal shaft section sealingly secured to the distal end of inner tubular member 16, so that its interior is in fluid communication with inflation lumen 22. An adapter 26 at the proximal end of catheter shaft 12 is configured to direct inflation fluid through arm 28 into inflation lumen 22 and to provide access to guidewire lumen 18. Balloon 24 has an inflatable working length located between tapered sections of the balloon. An expandable stent 30 is mounted on balloon working length. FIG. 1 illustrates the balloon 24 in an uninflated configuration prior to deployment of the stent 30. The distal end of catheter may be advanced to a desired region of a patient's body lumen 32 in a conventional manner, and balloon 24 inflated to expand stent 30, seating the stent in the body lumen 32.

A stent cover 40 is on an outer surface of the stent 30. In accordance with the invention, the stent cover is formed of silicone polyurethane, and preferably, extruded, melt processed porous silicone polyurethane. Stent cover 40 generally comprises a tubular body, which preferably conforms to a surface of the stent and expands with the stent during implantation thereof in the patient. Although stent cover 40 is illustrated on an outer surface of the stent 30 in FIG. 1, the stent cover of the invention may be provided on all or part of an inner and/or an outer surface of the stent 30.

Stent cover 40 is secured to the surface of the stent 30 before the stent is introduced into the patient's vasculature, and the balloon inflated to expand the stent to implant the stent and stent cover thereon in the patient's body lumen 32. In the embodiment illustrated in FIG. 1, the stent 30 is a balloon expandable stent. However, the stent cover 40 of the invention may be provided on a variety of conventional stents including self expanding stents. The stent cover 40 length may be, selected to fit a variety of conventionally sized stents, with a typical diameter of about 2 mm to about 10 mm. The stent cover 40 wall thickness is typically about 10 μm to about 150 μm, preferably about 10 μm to about 50 μm. The silicone polyurethane stent cover 40 has a high compliance during expansion of the balloon 24 and stent 30 thereon of about 0.02 to about 0.05 mm/atm, over a balloon inflation pressure range of about 2 to about 18 atm, depending on the stent and balloons system used. A porosity of greater than 50% to 60% is not preferred due to the reduction in wall strength as the porosity is increased. The stent cover 40 provides a biocompatible, biostable surface on the stent.

In another embodiment, the medical device formed of silicone polyurethane is a vascular graft. FIG. 5 illustrates vascular graft 50, generally comprising a tubular body 51 having a lumen 52 therein, and ports 53, 54 at either end of the graft 50. The graft 50 is configured for being implanted in the patient, and it may be expanded into place within a vessel, or surgically attached to a vessel such as to a free end or a side wall of a vessel. The graft 50 length is generally about 4 to about 80 mm, and more specifically about 10 to about 50 mm, depending on the application, and single wall thickness is typically about 40 μm to about 2000 μm, preferably about 100 μm to about 1000 μm. The diameter is generally about 1 to about 35 mm, preferably about 3 to about 12 mm, depending on the application. Stent cover 40 is similar to vascular graft 50, except it is on a stent as illustrated in FIG. 1.

The stent cover 40 or other medical device is preferably formed by a method comprising combining the silicone polyurethane and a porogen, preferably by compounding in an extruder and pelletizing the compounded material, and extruding the compounded silicone polyurethane/porogen into a desired shape such as a tubular body. In a presently preferred embodiment, the compounded silicone polyurethane/porogen is melt process extruded, in a single or twin screw extruder. In a presently preferred embodiment, the porogen is KCl, preferably ground to or otherwise provided with a particle size of about 10 μm to about 40 μm, and then dried and combined with the silicone polyurethane. The porogen is extracted from the extruded tubular body, preferably by immersing the tubular body in water for at least about 72 hours to leach the KCl out of the tubing. Extracting the porogen results in microporous tubing having a controlled pore size distribution of about 5 μm to about 75 μm, and a porosity of about 40% to about 70%, preferably about 50%, by weight of the silicone polyurethane material forming the tubing.

In another embodiment, a medical device formed of porous silicone polyurethane is a catheter balloon similar to balloon 24. The balloon preferably has at least a layer of porous silicone polyurethane. In a preferred embodiment, the porosity of the silicone polyurethane layer provides for delivery of an agent within the patient's body lumen from the pores of the silicone polyurethane. A variety of suitable conventionally known drug delivery balloon configurations can be used such as a multilayered balloon having a fluid-impermeable inner layer for inflating the balloon and a porous outer layer of the silicone polyurethane which is permeable to allow an agent to be delivered from inside the porous silicone polyurethane layer when the balloon is inflated. The dimensions of catheter 10 are determined largely by the size of the balloon and guidewires to be employed, catheter type, and the size of the artery or other body lumen through which the catheter must pass or the size of the stent being delivered. Typically, the outer tubular member 14 has an outer diameter of about 0.025 to about 0.04 inch (0.064 to 0.10 cm), usually about 0.037 inch (0.094 cm), the wall thickness of the outer tubular member 14 can vary from about 0.002 to about 0.008 inch (0.0051 to 0.02 cm), typically about 0.003 to 0.005 inch (0.0076 to 0.013 cm). The inner tubular member 16 typically has an inner diameter of about 0.01 to about 0.018 inch (0.025 to 0.046 cm), usually about 0.016 inch (0.04 cm), and wall thickness of 0.004 to 0.008 inch (0.01 to 0.02 cm). The overall length of the catheter 10 may range from about 100 to about 150 cm, and is typically about 135 cm. Preferably, balloon 24 may have a length about 0.5 cm to about 4 cm and typically about 2 cm, and an inflated working diameter of about 1 to about 8 mm, and in a preferred embodiment, an uninflated diameter of not greater than about 1.3 mm. Inner tubular member 16 and outer tubular member 14 can be formed by conventional techniques, for example by extruding and necking materials already found useful in intravascular catheters such a polyethylene, polyvinyl chloride, polyesters, polyamides, polyimides, polyurethanes, and composite materials.

In one embodiment, the medical device of the invention, such as stent cover 40, has a therapeutic or diagnostic agent impregnated in the porous silicone polyurethane for delivery within the patient. The stent cover 40 or other device is impregnated with the agent by a compounding the silicone polyurethane with the agent or by filling the pores of the silicone polyurethane cover by dipping or spraying, although a variety of suitable methods may be used. As a result, the agent is releasably contained within the pores of the silicone polyurethane material, and diffuses out of the pores after the device is implanted in the patient. A variety of suitable agents may be used including antithrombogenic agents, antibiotic agents, antitumor agents, antiviral agents, antiangiogenic agents, angiogenic agents, anti-inflammatory agents. The agent is preferably present in the stent cover 40 or other medical device in a loading of about 0.05% to about 0.5%.

While the present invention is described herein in terms of certain preferred embodiments, those skilled in the art will recognize that various modifications and improvements may be made to the invention without departing from the scope thereof. For example, in the embodiment illustrated in FIG. 1, the catheter is over-the-wire stent delivery catheter. However, one of skill in the art will readily recognize that other types of intravascular catheters may be used, such as rapid exchange balloon catheters having a distal guidewire port and a proximal guidewire port and a short guidewire lumen extending between the proximal and distal guidewire ports in a distal section of the catheter. Moreover, although individual features of one embodiment of the invention may be discussed herein or shown in the drawings of the one embodiment and not in other embodiments, it should be apparent that individual features of one embodiment may be combined with one or more features of another embodiment or features from a plurality of embodiments.

What is claimed is:

1. A medical device or component thereof, comprising a body formed of melt process extruded, porous silicone polyurethane material.

2. The medical device or component thereof of claim 1 wherein the porosity of the silicone polyurethane material is about 20% to about 90% by weight of the material.

3. The medical device or component thereof of claim 1 wherein the porosity of the silicone polyurethane material is about 50% or less by weight of the material.

4. The medical device or component thereof of claim 1 wherein the body comprises a tube having a wall thickness of about 40 μm to about 2000 μm.

5. The medical device or component thereof of claim 4 wherein the wall of the body is fluid permeable.

6. The medical device or component thereof of claim 1 wherein the silicone polyurethane is selected from the group consisting of polyether silicone polyurethane, and polycarbonate silicone polyurethane.

7. The medical device or component thereof of claim 1 wherein the medical device or component thereof is selected from the group consisting of a stent cover, a vascular graft, a pacemaker lead cover, and a catheter balloon.

8. The medical device or component thereof of claim 1 wherein the medical device component is a stent cover including a therapeutic or diagnostic agent releasably contained within the silicone polyurethane material.

9. A stent cover formed at least in part of a silicone polyurethane material.

10. A stent cover, comprising a body formed of melt process extruded, porous silicone polyurethane material.

11. The stent cover of claim 10 wherein the silicone polyurethane material has a porosity of about 20% to about 90% by weight of the material.

12. The stent cover of claim 10 wherein the silicone polyurethane material has a porosity of about 50% or less by weight of the material.

13. The stent cover of claim 10 having a wall thickness of about 40 μm to about 2000 μm.

14. The stent cover of claim 10 wherein the silicone polyurethane material has a uniform porosity.

15. A medical device component selected from the group consisting of a pacemaker lead cover and a catheter balloon, formed at least in part of melt process extruded, porous silicone polyurethane material.

16. A medical device or component thereof, comprising a body formed of melt process extruded, porous silicone polyurethane material, the body being formed by a process comprising:
a) combining a silicone polyurethane polymeric material with a porogen;
b) melt process extruding the combined polymeric material and porogen into a tubular body formed of the polymeric material and porogen; and
c) extracting the porogen from the tubular body, to form the melt process extruded, porous silicone polyurethane body.

17. A method of making a medical device or component thereof having at least a part formed of a silicone polyurethane material, comprising
a) combining a silicone polyurethane polymeric material with a porogen;
b) melt process extruding the combined polymeric material and porogen to form an extrudate; and
c) extracting the porogen from the extrudate, to form a melt process extruded, porous silicone polyurethane part.

18. The method of claim 17 wherein (b) comprises heating the combined polymeric material and porogen so that the polymeric material is molten.

19. The method of claim 17 wherein the medical device component is a stent cover, and the combined polymeric material and porogen is melt process extruded into a tubular body.

20. The method of claim 17 wherein the porogen is an inorganic salt, and the polymeric material and porogen are combined by compounding in an extruder.

21. The method of claim 17 wherein extracting the porogen comprises dissolving the porogen, to produce the extruded, melt processed, porous silicone polyurethane part having a porosity of about 20% to about 90% by weight of the material.
